(19) United States
(12) Patent Application Publication
(10) Pub. No.: US 2008/0056285 A1
(43) Pub. Date: Mar. 6, 2008

(54) Method and system for connecting wireless personal area network (WPAN) devices through display systems

(76) Inventors: Liam B. Quinn, Austin, TX (US); Fahd B. Pirzada, Austin, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/511,818

(22) Filed: Aug. 29, 2006

(51) Int. Cl. H04L 12/56

(52) U.S. Cl. 370/401

(57) ABSTRACT

Methods and systems are disclosed for connecting multiple wireless personal area network (WPAN) or ultra wide band (UWB) devices to a host information handling system having a display system providing WPAN connection for WPAN peripheral devices and to serve as a WPAN hub for the WPAN peripheral devices. A data communication interface associated with the display system provides communications to a host information handling system. The WPAN peripheral devices are docked as WPAN devices for the host information handling system. Subsequent docking between the host and a display monitor is detected by device drivers. A USB hub with UWB support is located in a display monitor. The USB hub can connect to a workstation, docking station, portable computer, or the like. The display monitor can be a storage device, and can store UWB drivers in memory on the display monitor.

### TECHNICAL FIELD OF THE INVENTION

This invention relates to methods and systems for connecting multiple wireless personal area (WPAN) devices to host information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some information handling systems have a plurality of wired and/or wireless peripheral devices that are connected to or associated with the information handling system. These peripheral devices can include devices such as printers, scanners, displays, personal digital assistants (PDAs), portable computers, music players, hard drives, flash drives, cellular phones, keyboards, mouse and/or any other desired peripheral device. Wired connections for such devices are often implemented as USB (Universal Serial Bus) connections using USB cables or connectors with each device then being registered with the host information handling system. One or more USB hubs can also be attached to the host information handling system. These USB hubs allow a plurality of additional devices to be connected through it to the host information handling system. A USB hub allows the connection of multiple USB devices to a single USB port on an information handling system. Peripheral connectivity using wired cables and connectors, however, can result in issues such as reach, placement, port expansion, cost and cable management.

Because of the disadvantages associated with wired solutions, wireless connection schemes and protocols have been and are being developed to provide improved wireless connectivity for peripheral devices. These wireless connections between peripheral devices and a host information handling system are often deemed to make up a wireless personal area network (WPAN) associated with the particular host information handling system. WPAN devices can be implemented to communicate with the host information handling system through one or more wireless communication protocols, such as Bluetooth, ultra wideband (UWB), wireless USB (WUSB) and/or other WPAN wireless protocols. In addition, each of these wireless protocols and/or the WPAN devices themselves will often require driver support in the operating system (OS) for the host information handling system. Currently, information handling systems often include circuitry and software to allow connectivity to WPAN devices through one or more WPAN wireless protocols; however, there is no current consistent WPAN configuration. And many existing information handling systems have limited WPAN communication capabilities or no WPAN communication capabilities at all.

### SUMMARY OF THE INVENTION

The present invention provides a method and system for connecting wireless personal area network (WPAN) devices to a host information handling system through a display system. The display system provides a WPAN connection for the WPAN peripheral devices and serves as a WPAN hub for the WPAN peripheral devices. The display system thereby allows the WPAN peripheral devices to be connected to the host information handling system as WPAN devices without requiring the host information handling system to provide the direct WPAN communication link to the WPAN devices. A wired or wireless data communication interface can be associated with the display system to provide data communications associated with the WPAN devices between the display system and the host information handling system.

In one embodiment, a USB hub located in the display system can be used as the data communication interface with the host information handling system. This embodiment can take advantage of the capabilities of an integrated USB hub located in a display monitor to extend reach and connectivity for up to 127 peripherals through standard USB protocols and connection techniques. In addition, ultra wideband (UWB) communication protocols can be used as a wireless transport mechanism to allow WPAN communications between the display system and the WPAN peripheral devices. The integrated USB hub with UWB support according to this embodiment of the present invention provides an advantage for wireless docking architecture for WPAN peripheral devices, which can include devices such as printers, scanners, displays, personal digital assistants (PDAs), portable computers, music players, hard drives, flash drives, cellular phones, keyboards, mouse and/or any other desired peripheral WPAN device. As described below, other features and variations can be implemented, if desired, and related systems and methods can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a block diagram of an embodiment including a display system configured to provide connections between an information handling system and multiple wireless personal area network (WPAN) devices.

FIG. 2 is a block diagram of an embodiment including a display system utilizing ultra wideband (UWB) communications to provide WPAN connection links between the display system and the WPAN devices and a USB (Universal Serial Bus) hub to provide data communications between the information handling system and the display system.

FIG. 3A is a block diagram of an embodiment in which the information handling system is a workstation computer connected to UWB-enabled WPAN devices through the display system.

FIG. 3B is a block diagram of an embodiment in which the information handling system is a portable computer docking station and a portable computer that are connected to UWB-enabled WPAN devices through the display system.

FIG. 3C is a block diagram of an embodiment in which the information handling system is a portable computer connected to UWB-enabled WPAN devices through a display system.

FIG. 4 is a flowchart illustrating a wireless docking process for connecting WPAN devices to an information handling system through a display system, including device driver loading, if needed.

### DETAILED DESCRIPTION OF THE INVENTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a server computer system, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The present invention provides systems and methods for connecting wireless personal area network (WPAN) peripheral devices to host information handling systems through display systems. As discussed above, WPAN peripheral devices can be implemented to communicate with a host information handling system through one or more wireless communication protocols, such as Bluetooth, ultra wideband (UWB), wireless USB (WUSB) and/or other WPAN wireless protocols. UWB communications are currently a protocol that is being considered as advantageous due to its potential to provide high-speed, short-range data transfers of content between devices in the home or office with reduced costs and without wired connections. It is also noted that although WPAN devices can also communicate with information handing systems through wireless local area network protocols, such as 802.11a/b/g protocols, WPAN communications as used herein refer to be high bandwidth and short-range communications, such as communications of less than about 10 meters, and communications that are intended to connect peripheral devices to host information handling systems for cable replacement applications.

By utilizing display systems to provide connectivity for WPAN peripheral devices, embodiments of the present invention can provide improved connectivity for information handling systems and can provide connectivity to WPAN devices using a variety of WPAN communication protocols without requiring the host information handling system to have those capabilities. The extensibility of wireless docking enabled by the bandwidth capabilities of UWB, for example, can be provided to a non-UWB enabled information handling system through a display system configured to provide a host wired adapter (HWA) for wireless USB devices and configured to communicate with the information handling system over separate wireless or wired connection, such as wireless USB (WUSB) or USB connection existing between the display system and the information handling system.

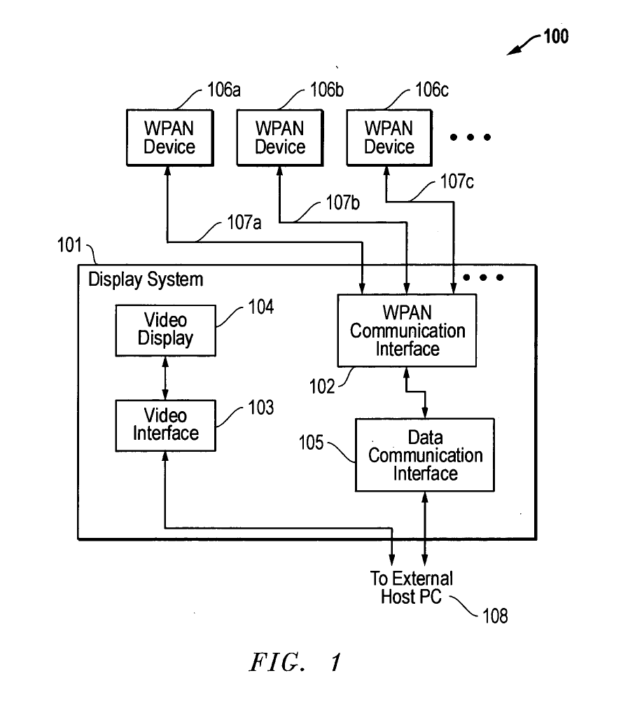

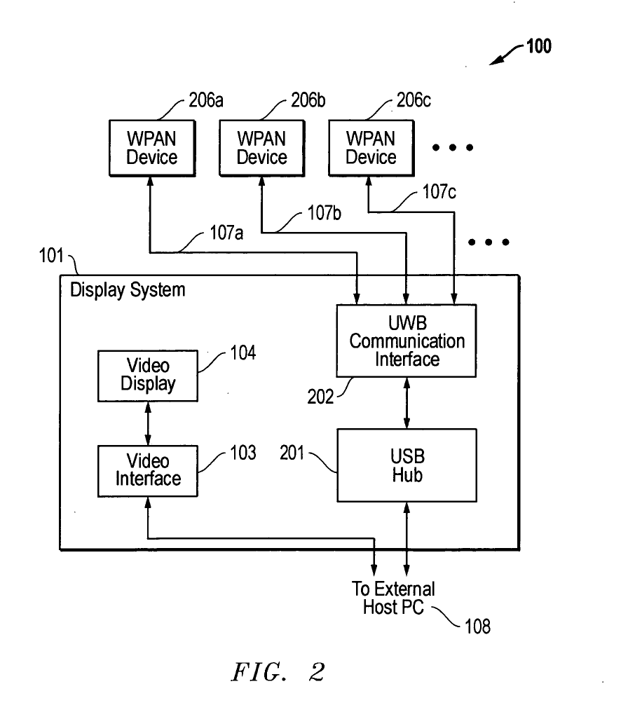

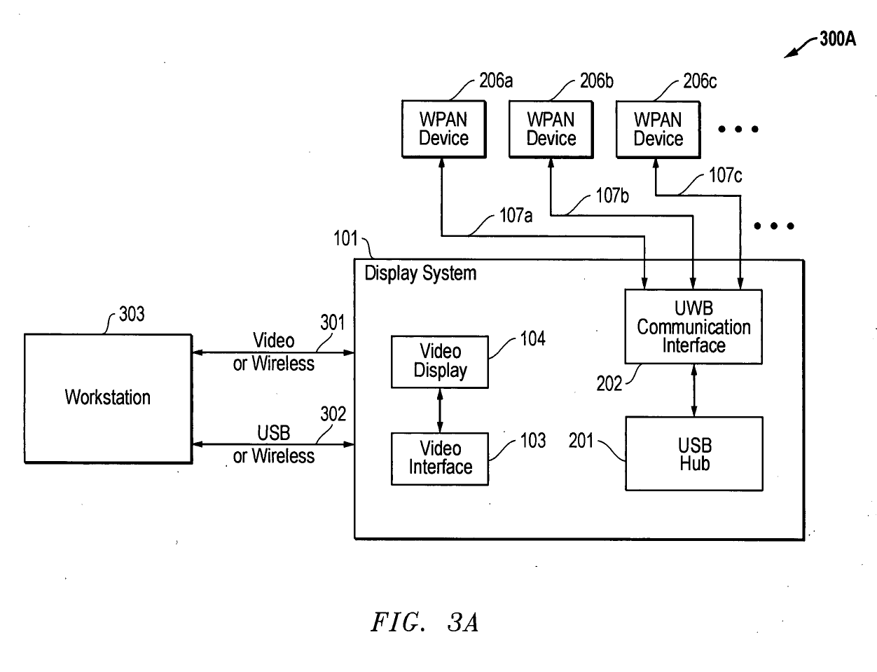

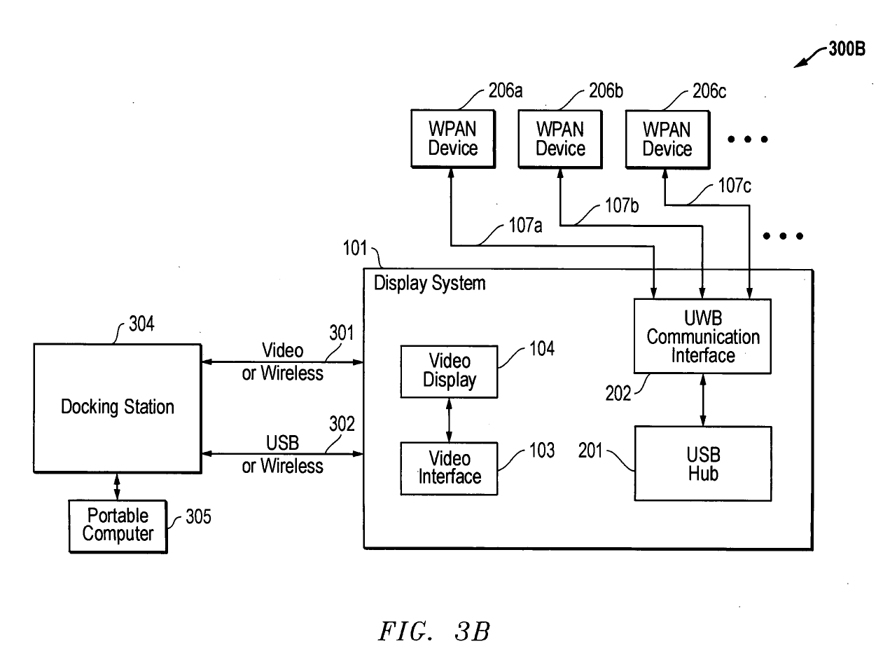

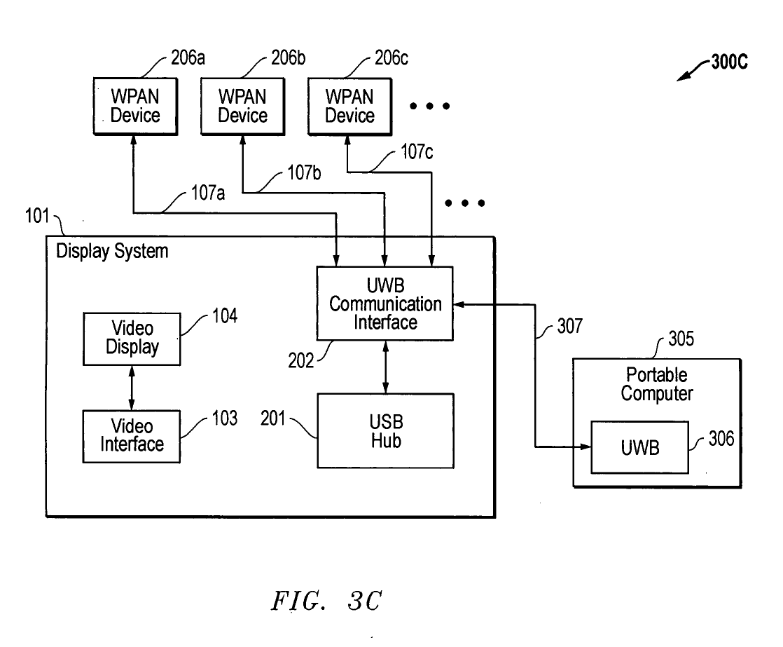

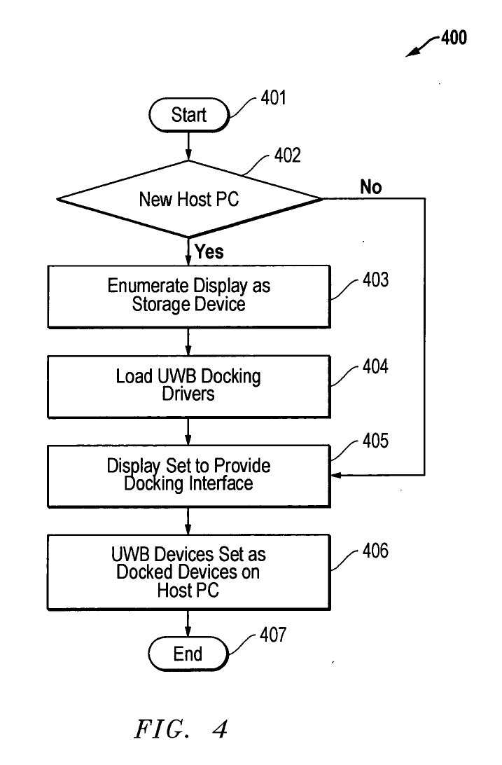

The invention is now further described with respect to example embodiments set forth in the drawings. FIG. 1 provides an embodiment in which the display system is providing a WPAN communication interface for multiple WPAN devices. FIG. 2 provides an embodiment in which the WPAN communication interface is a UWB connection hub and in which the data communication interface is a USB hub. FIGS. 3A, 3B and 3C provide example system embodiments for information handling systems coupled to WPAN peripheral devices through a display system. And FIG. 4 is a flow diagram for an example process for docking WPAN peripheral devices to a host information handling system through a display system.

FIG. 1 is a block diagram of embodiment 100 in which a display system 101 provides a WPAN communication interface 102 for a plurality of WPAN peripheral devices 106a, 106b, 106c, . . . . The display system 101 can be any desired display system, including a flat panel LCD (liquid crystal display) display system, a CRT (cathode ray tube) display system, and/or any other desired display system. The display system 101 is configured to provide a WPAN communication interface 102 for one or more WPAN peripheral devices 106a, 106b, 106c . . . , such as printers, scanners, displays, personal digital assistants (PDAs), portable computers, music players, hard drives, flash drives, cellular phones, keyboards, mouse and/or any other desired peripheral WPAN device. The display system 101 is configured to serves as a WPAN hub for the WPAN devices 106a, 106b, 106c . . . that communicate through WPAN connections 107a, 107b, 107c . . . to the display system 101 via the WPAN communication interface 102. It is noted that the WPAN communication interface 102 will typically include an antenna and associated circuitry configured to send and receive communications between the display system 101 and the WPAN peripheral devices 106a, 106b, 106c . . . according to one or more WPAN communication protocols (e.g., devices connected through Bluetooth, WUSB, IEEE 1394, IP and/or other WPAN protocols).

The WPAN communication interface 102 can then be connected to a data communication interface 105 located within and/or associated with the display system 101. The data communication interface 105 provides data communication connections 108 to a host information handling system. The WPAN devices 106a, 106b, 106c . . . are docked through the display system 101 as one or more WPAN devices for the host information handling system. The display system 101 also provides a video display 104 that is connected to a video interface 103. The video interface 103 is configured to be coupled to the host information handling system or external host personal computer (PC) through communication connections 108. The data communication interface 105 and the video communication interface 103 can be implemented as one or more wired connections, one or more wireless links, or a combination thereof, as desired.

FIG. 2 is a block diagram of an embodiment 200 in which a display system 101 includes a UWB communication interface 202 and a USB hub 201. The UWB communication interface 202 provides the WPAN communication interface for a plurality of UWB-enabled WPAN peripheral devices 206a, 206b, 206c . . . , and the USB hub 201 provides the data communication interface with the external host PC or host information handling system through communications 108. Otherwise, the display system 101 shown in FIG. 2 is similar to the display system 101 of FIG. 1. In the embodiment 200 of FIG. 2, the display system 101 still serves as a WPAN hub by providing UWB connections for the UWB peripheral devices 206a, 206b, 206c . . . through UWB connections links 107a, 107b, 107c . . . . The UWB communication interface 202 acts as a UWB hub thereby allowing multiple UWB peripheral devices to connect through it to the USB hub 201 and then be recognized and docked as a device on the host information handling system. The USB hub 201 provides data communications to the host information handling system with respect to which the UWB peripheral devices 106a, 106b, 106c . . . are docked as one or more WPAN devices. The display system 101 utilizes the USB hub 201 and the UWB support though UWB communication interface 202 to provide a wireless docking structure for the UWB peripheral devices 106a, 106b, 106c . . . so as to allow connectivity to the host information handling system for the UWB-enabled peripheral devices using the UWB hub 202 as the wireless transport mechanism.

FIGS. 3A, 3B and 3C provide example embodiments that take advantage of wireless peripheral docking connectivity through a display system. FIG. 3A depicts an embodiment 300A including a workstation coupled to a display system providing wireless connectivity to UWB devices. FIG. 3B depicts an embodiment 300B including a docking station, to which a portable computer can be docked, coupled to a display system providing wireless connectivity to UWB devices. And FIG. 3C depicts an embodiment 300C including a portable computer coupled to a display system providing wireless connectivity to UWB devices.

FIG. 3A is a block diagram of an embodiment 300A including a workstation computer 303 coupled to a display system 101 similar to the embodiment depicted in FIG. 2. The workstation computer 303 communicates with the video interface 103 within display system 101 using a wired video connection 301 and/or a wireless connection. The workstation computer 303 communicates with the USB hub 201 within display system 101 using a wired USB connection 302 and/or a wireless connection. As stated above, the data communication interface 105 and the video communication interface 103 can be implemented as one or more wired connections, one or more wireless links, or a combination thereof, as desired.

UWB communication interface 202 provides a UWB hub, and USB hub 201 is detected as a storage device by the workstation computer through the USB connection. As such, the display system is registered within the operating system (OS) of the workstation computer 303 as a host wire adapter (HWA). This enumeration of the display system 101 as a host wire adapter (HWA) allows the display system 101 to manage multiple UWB-enabled WPAN devices through the USB hub 201. The UWB peripheral devices 206a, 206b, 206c . . . are registered within the OS of the workstation computer 303 as device wire adapters (DWA). In addition, any of these UWB devices 206a, 206b, 206c . . . can be made automatically available to the workstation computer 303 when it comes within range and a UWB communication link is formed. By using the USB hub 201 to provide communications between the display system and the workstation computer 303, the UWB-enabled WPAN devices 206a, 206b, 206c . . . can be connected through the display system 101 even if UWB connectivity is not configured on the workstation computer 303. As such, this embodiment allows wide adoption of UWB-enabled WPAN devices 206a, 206b, 206c . . . in environments, such as corporate environments, where installed computers and related motherboard chasses lack UWB integration.

As discussed in more detail with respect to FIG. 4, device drivers for the UWB-enabled WPAN peripheral devices 206a, 206b, 206c . . . can be stored in memory on the display system 101. Each time the display system 101 is then connected to workstation computer 303 and a WPAN device is connected, these drivers can be loaded to the workstation computer 303 to enable enhanced docking functionality. Still further, any new workstation, portable computer, or other computer system being connected to the display system can have available to it the appropriate device drivers for the WPAN peripheral devices 206a, 206b, 206c . . . without requiring these device drivers to be directly loaded on the connecting system. Any subsequent docking between the workstation computer 303, or other system, and the display system 101 can then be detected and the loading of the device drivers can be skipped, if unnecessary. The display system 101, therefore, allows remote WPAN peripheral devices (e.g., devices connected through Bluetooth, WUSB, IEEE 1394, IP and/or other WPAN protocols) to be listed as available devices using the USB hub 201 in the display system 101. In addition, with UWB bandwidths scaling to 1 Gbit/sec and beyond, it may be desirable to use a wireless link to transport rendered video data for video connection 301 rather than using a wired video cable.

Advantageously, by having the display system 101 act as a central hub for WPAN peripheral device connectivity, scaling of WPAN connectivity is greatly enhanced. In additiona, when using a workstation computer 303, the display system 101 will typically provide a superior antenna placement compared to an antenna in a mother board chassis, thereby providing a performance advantage to provide better connectivity with WPAN peripheral devices.

FIG. 3B shows an alternative embodiment 300B. As depicted, display system 101 is now connected to a portable computer 305 through a portable computer docking station 304. Otherwise, FIG. 3B is similar to FIG. 3A. As with the embodiment of FIG. 3A, the display system 101 can be detected as a storage device when a USB cable 302 connects to a docking station 304 which is in turn connected to a portable computer 305.

FIG. 3C shows an additional alternative embodiment 300C. As depicted, display system 101 is now connected to a portable computer 305 through a UWB communication interface 306 located within the portable computer 305. The UWB communication interface 202 provides both connectivity to the UWB-enabled devices 206a, 206b, 206c . . . and to the portable computer 305. It is noted that the embodiment 300C of FIG. 3C and the embodiment 300A of FIG. 3A could be combined such that the host information handling system is a workstation computer 303 and the portable computer 305 is another WPAN peripheral device that is connecting to the workstation computer 303 through the display system.

It is noted that the system configuration embodiments of FIGS. 3A, 3B and 3C are only example embodiments. Other configurations and implementations could also be utilized while still taking advantage of a display system providing WPAN connectivity from one or more WPAN peripheral devices to a host information handling system.

FIG. 4 is a flowchart of an example process embodiment 400 showing the steps for wireless docking for one or more WPAN peripheral devices through a display system. First, in step 401, the display system is connected to a host information handling system, such as a host personal computer (PC), and docking starts. Next, in step 402, a determination is made regarding whether the host PC is a new host PC. If the determination is “No,” step 405 is reached where the display system is set to provide a docking interface. Next, in step 406, the USB devices are set as docked devices on the host PC. As such, WPAN peripheral devices (e.g., devices connected through Bluetooth, WUSB, IEEE 1394, IP and/or other WPAN protocols) connected through the display system can be allowed and can be listed as available devices using the display system as a WPAN hub.

If the determination in step 402 is “Yes,” step 403 is first reached where the display system is enumerated as a storage device. Next, in step 404, the WPAN or UWB docking drivers are loaded from the display system to the host PC. If configured to stored device drivers for the WPAN peripheral devices, the display system can also provide the host information handling system appropriate device drivers. As above, step 405 is then reached where the display is set to provide a docking interface. In step 405, the UWB devices connected to the display system are then set as docked devices on the host personal computer (PC) or host information handling system. Docking is completed and the process ends in step 407.

It is noted that the docking process of FIG. 4 is only an example embodiment. Other docking process configurations and implementations could also be utilized while still taking advantage of a display system providing WPAN connectivity from one or more WPAN peripheral devices to a host information handling system

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method for connecting multiple wireless personal area network (WPAN) devices to a host information handling system, comprising:
configuring a display system to provide a WPAN connection for one or more WPAN peripheral devices and to serve as a WPAN hub for the one or more WPAN peripheral devices; and
communicating between a host information handling system and the display system to cause the one or more WPAN peripheral devices to be docked as one or more WPAN devices for the host information handling system.

2. The method of claim 1, further comprising utilizing a data communication interface associated with the display system to provide communications to a host information handling system.

3. The method of claim 2, further comprising utilizing a USB (universal serial bus) hub as the data communication interface.

4. The method of claim 3, further comprising providing UWB-enabled WPAN devices as WPAN devices and utilizing a UWB communication interface within the display system to provide a UWB link between the display system and the WPAN devices.

5. The method of claim 4, further comprising connecting the USB hub to a workstation computer.

6. The method of claim 4, further comprising connecting the USB hub to a docking station configured to accept a portable computer.

7. The method of claim 2, further comprising connecting the display system to a portable computer through a wireless communication.

8. The method of claim 4, further comprising loading UWB device related docking drivers from a display monitor to a host.

9. The method of claim 8, wherein subsequent docking between the host and the display monitor is detected by device drivers.

10. A system for connecting multiple wireless personal area network (WPAN) devices to a host information handling system, comprising:
a display system configured to provide a WPAN connection for one or more WPAN peripheral devices and to serve as a WPAN hub for the one or more WPAN peripheral devices; and
a data communication interface associated with the display system and configured to provide communications to a host information handling system;
wherein the display system is configured to allow one or more WPAN peripheral devices to connect with a host information handling system through the display system.

11. The system of claim 10, wherein the WPAN connection comprises one or more UWB links between the display system and the WPAN peripheral devices to provide wireless docking for the WPAN peripheral devices.

12. The system of claim 11, wherein the data communication interface comprises a USB (universal serial bus) hub coupled to the display system.

13. The system of claim 10, further comprising a workstation computer coupled to the display system through the data communication interface, the WPAN peripheral devices being connected to the workstation computer through the display system.

14. The system of claim 13, wherein the workstation computer further communicates with the display system through a video communication interface.

15. The system of claim 14, wherein the data communication interface and the video communication interface comprise one or more wireless links.

16. The system of claim 10, further comprising a portable computer docking station coupled to the display system through the data communication interface, the WPAN peripheral devices being connected to the workstation computer through the display system.

17. The system of claim 10, further comprising a portable computer coupled to the display system through the data communication interface, the WPAN peripheral devices being connected to the workstation computer through the display system.

18. The system of claim 17, wherein the portable computer is configured to communicate with the display system through a WPAN connection.

19. The system of claim 10, wherein the display system is configured to store one or more device drivers for the WPAN peripheral devices and to provide the device drivers, if needed, to a host information handling system connected to communicate with the WPAN peripheral devices through the display system.

20. A display system for connecting multiple wireless personal area network (WPAN) devices to a host information handling system, comprising:
a video display;
a video interface configured to be coupled to a host information handling system;
a WPAN communication interface configured to provide a WPAN connection for one or more WPAN peripheral devices and to serve as a WPAN hub for the one or more WPAN peripheral devices; and
a data communication interface configured to provide communications to a host information handling system to allow the one or more WPAN peripheral devices to allow one or more WPAN peripheral devices to connect with a host information handling system through the display system.

21. The display system of claim 20, wherein the WPAN connection comprises one or more UWB links between the display system and the WPAN peripheral devices to provide wireless docking for the WPAN peripheral devices.

22. The system of claim 21, wherein the data communication interface comprises a USB (universal serial bus) hub coupled to the display system.
